(19) United States
(12) Patent Application Publication
(10) Pub. No.: US 2004/0196363 A1
(43) Pub. Date: Oct. 7, 2004

(54) Video identification verification system

(76) Inventors: Gary Diamond, Southbury, CT (US); Stephen F. Hennessey, Hartland, CT (US)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(21) Appl. No.: 10/816,388

(22) Filed: Apr. 1, 2004

Related U.S. Application Data
(60) Provisional application No. 60/459,481, filed on Apr. 1, 2003.

(51) Int. Cl. H04N 7/18; H04N 9/47; G06K 9/00

(52) U.S. Cl. 348/64

(57) ABSTRACT

A video identification verification system has a light tray for insertion of an ID card. The card when inserted has its top surface recorded on a video recorder. The image of the person presenting the card is also recorded along with a time/date stamp. The light tray has side wall diffusers and associated LEDs that provide even illumination to the light tray so as to facilitate recording of ID cards of all types.

### CROSS-REFERENCE TO RELATED APPLICATIONS

This application claims priority under 35 USC §119(e) to U.S. Provisional Patent Application No. 60/459,481 filed on Apr. 01, 2003.

### TECHNICAL FIELD

The present invention relates to video identification systems, particularly for recording images of identification cards in association with the people presenting the identification cards.

### BACKGROUND OF THE INVENTION

Identification cards can be used for many purposes. One purpose for which they are commonly used is to authenticate some aspect of the person who presents the card to a third party. Thus, for instance, identification cards are used in commercial establishments that serve alcohol to ensure that the person desiring to enter the establishment and purchase such beverages are of at least the minimum age in that jurisdiction for being legal to consume such beverages. Of course, there have been problems with people presenting identification cards which have been altered or which are forged and which purport to show the presenter of the card as having a certain age when in fact it is not true. This has presented a problem to commercial establishments that serve alcohol since in many states in the United States and in other countries there is a requirement that the commercial establishment take affirmative steps to ensure that its patrons meet the minimum age for consuming alcoholic beverages and the like.

Since many identification cards, such as driver's licenses, contain a photographic image of the person, the commercial establishment typically looks at the presented identification to see if the presenter of the card matches the photographic image on the card. This has reduced the use of cards by one person other than its true owner, but has not reduced the altering and forgery of identification cards. Of course, sometimes a potential patron presents one card to the commercial establishment upon entry, which in fact is a forged or altered card, but later, if stopped by law enforcement for some infraction, may show their authentic identification card (typically showing that the person's age is less than that shown on the forged or altered card). The commercial establishment then has the difficult task of proving that the card presented to them was in fact different from the one which the person now shows as their authentic card. There is therefore a need in the industry to verify and record not only the identity of the person who presents the card to a commercial establishment, but also to record the actual card presented, so that if there is a later question about the card presented to the establishment, the establishment can readily show that they were in fact presented a card other than that which turns out to be the presenter's authentic card.

### SUMMARY OF THE INVENTION

The present invention addresses the above-mentioned problems by a video identification verification system which is able to record the image of the presented identification card as well as the image of the presenter of that card, and may also record the audio in the area of the verification system. The video identification verification system of the present invention comprises a light tray which is dimensioned for receipt of an identification card as well as a light diffuser positioned relative to the bottom wall of the light tray, wherein the diffuser is positioned such that a light source positioned relative thereto causes the light that passes through the diffuser to illuminate the identification card positioned on the bottom wall of the light tray in a manner which provides for acceptable imaging by a video camera associated with the identification verification system.

The verification system can further include electronic circuitry for controlling the activation of the camera so as to cause the image from the camera to be recorded on an associated video recording system, such as a video cassette recorder (VCR), when an identification card is positioned in the light tray.

The verification system can further include a second video camera on a cabinet housing the light tray, wherein the second camera is positioned so as to image an area extending in a direction away from the cabinet so as to be able to record the image of the person presenting the identification card, wherein the electronic circuitry further records the video information from the second video camera onto the video recording device during times prior to and/or after recording of the image associated with the identification card inserted into the light tray.

The video identification verification system can further include at least one microphone in cooperative engagement with the electronic circuitry for recording audio information in the vicinity of the video identification verification system throughout the time that the identification system is operating.

The video identification verification system may also include a time and date stamp generator for recording the time and date as the system is in operation.

The light source of the video identification verification system may include light emitting diodes (LEDs) that generate a white-bluish colored light so as to evenly illuminate identification cards and to record its image even when multi-colored printing is on the card. The video identification verification system light tray can further include an angular relationship between the bottom wall and the side wall diffuser such that the side wall diffuser is positioned relative to the bottom wall at an angle between approximately 35 to 64 degrees. The light tray may further include a second side wall similarly positioned on the opposite side wall to the first side wall, with each side wall having light emitting diodes forming the light source. The resulting light tray has been experimentally found to effectively image ID cards that are in color, thereby allowing the image of the ID card to be recorded in color by the color ID camera.

The present invention is further directed to a light tray for use in a video identification verification system, wherein the light tray has a bottom wall for receipt of an identification (ID) card and at least one side wall diffuser positioned relative to the bottom wall at an angle between approximately 35 to 64 degrees. The light tray may further include a second side wall diffuser positioned opposite the first side wall diffuser and relative to the bottom wall so as to form an angle between 35 to 64 degrees. The light tray may further include a back wall wherein the back wall and bottom wall of the light diffuser are fabricated from methylacrylic resin slab type material. The light tray side wall diffusers may also be preferably fabricated from an acrylic sheet material.

The light tray may further include a relationship between the bottom wall and the side walls for receipt of one or two LED holders, each for mounting LEDs such that when the holders are positioned onto the light tray, the LEDs project light toward the adjacent diffuser side wall so as to provide even illumination for proper recording of a video image of the identification card in the light tray.

### BRIEF DESCRIPTION OF THE DRAWINGS

For a fuller understanding of the nature and objects of the present invention, reference should be made to the following detailed description taken in conjunction with the following drawings in which:

FIG. 1 is a perspective view of a video identification verification system according to the present invention;

FIG. 2 is a block diagram of the verification system shown in FIG. 1;

FIG. 3 is a schematic diagram of the electronic circuitry and associated illumination devices for the verification system according to the present invention;

FIG. 4 is a plan view of the light emitting diode board which houses the light emitting diodes for use in the verification system of the present invention;

FIG. 5 is a perspective view of the light tray and video camera forming part of the verification system shown in FIG. 1;

FIG. 6 is a perspective view of the control module for housing the electronic circuitry and light tray of the verification system of the present invention; and

FIG. 7 is a schematic diagram of the microphone and associated circuit to operate the microphone.

### DETAILED DESCRIPTION

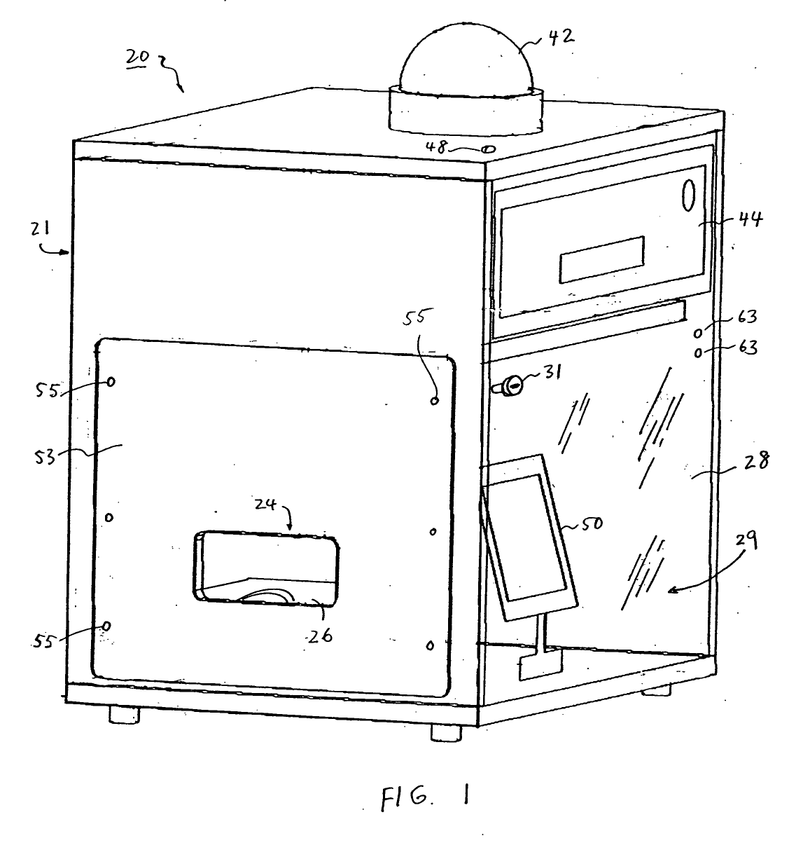

As best seen in FIG. 1, the video identification verification system 20 includes a cabinet 21 defining an interior enclosure space 29 for housing the various components of the verification system. The cabinet 21 is shown with a hinged door 28 which is typically made from a clear material, such as plastic or shatter-proof glass, with a key lock 31 for ensuring that the door is only opened by authorized personnel. Within the enclosure 29 is mounted a video cassette recorder (VCR) 44 and an LCD monitor. A control module 51 is also positioned within the enclosure 29 with the control module housing a light tray 24 and an electronic circuit 27 for overall control and operation of the verification system 20. Connectors 59 are provided on the control module to connect the various components of the system. Such connectors and associated cables (not shown) are well known in the art.

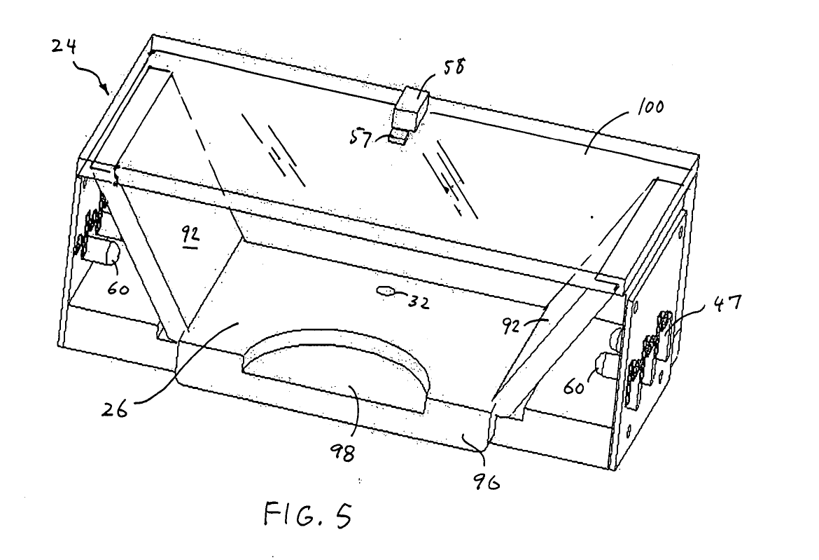

As seen in FIGS. 1 and 5, the light tray 24 has a bottom wall 96 and an associated card receiving region 26 which is dimensioned for receipt of identification (ID) cards 30. Such cards typically are driver's licenses, but could also be any other type of ID card used for purposes of identification.

As will be explained more fully below with respect to the electronic circuitry, when the ID card is within the tray, the cards upper surface is illuminated by a plurality of light emitting diodes (LEDs) 60. Furthermore, the ID card when inserted into the card receiving area causes the electronic circuitry to initiate recording of an image of the ID card via a video camera 46 which is preferably a low light color camera. This video camera therefore acts as an ID camera for the ID card. As seen in FIG. 1, mounted atop the cabinet 21 is a second video camera 42 which records the image of anyone positioned in front of the verification system 20. This camera is also preferably a low light color camera. In this manner, when the verification system is positioned at the entrance to an establishment requiring that ID cards be checked to ensure that the people entering are of a minimum legal age, the identity of the person presenting the card to the operator of the verification system is established in conjunction with the recording of the image of the ID card when placed in the card receiving region. This thereby provides the ability to record on the VCR 44 the image of the person presenting the ID card to the operator of the system. Furthermore, the electronic circuitry 27 generates a date and time stamp simultaneously recorded on the videotape so that a time record is maintained for each ID card presented to the operator of the establishment. The overall result is that the ID card is recorded on the videotape in combination with the image of the person presenting the card, thereby facilitating responses to inquiries which may later develop as to the authenticity of the card as well as the person who in fact presented the card to the establishment using the video identification system.

Furthermore, the video identification verification system can include a microphone 48 positioned on the cabinet 21 so as to record the ambient sounds and voices in the general area of the identification system. This further helps to record the identity of each person presenting an ID card to the operator of the verification system. The overall result is that the verification system acts as a deterrent to the use of false ID cards by underage individuals with regard to establishments serving alcohol, tobacco, and the like, and also provides the ability for such establishments to verify that they were in fact presented an ID card which ostensibly showed the person presenting the ID card as being of proper minimum legal age. The verification system also records the demeanor of people, which may also be helpful in terms of determining whether the operator of the establishment was exercising proper screening of people desiring entrance into the establishment.

Of course, the video identification verification system can be used for other applications in addition to establishments serving alcohol or other controlled substances and in fact is potentially useful in any situation where an ID card is to be presented by someone who purports to be the person shown on that identification card.

Operation of Video Identification Verification System

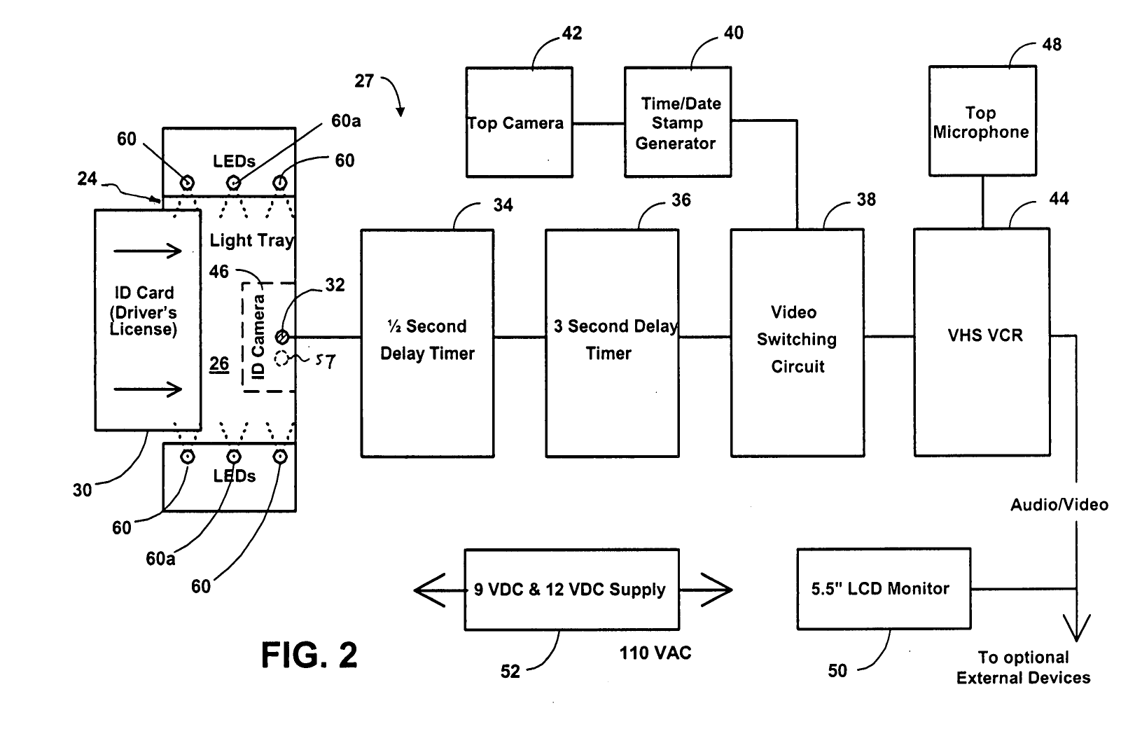

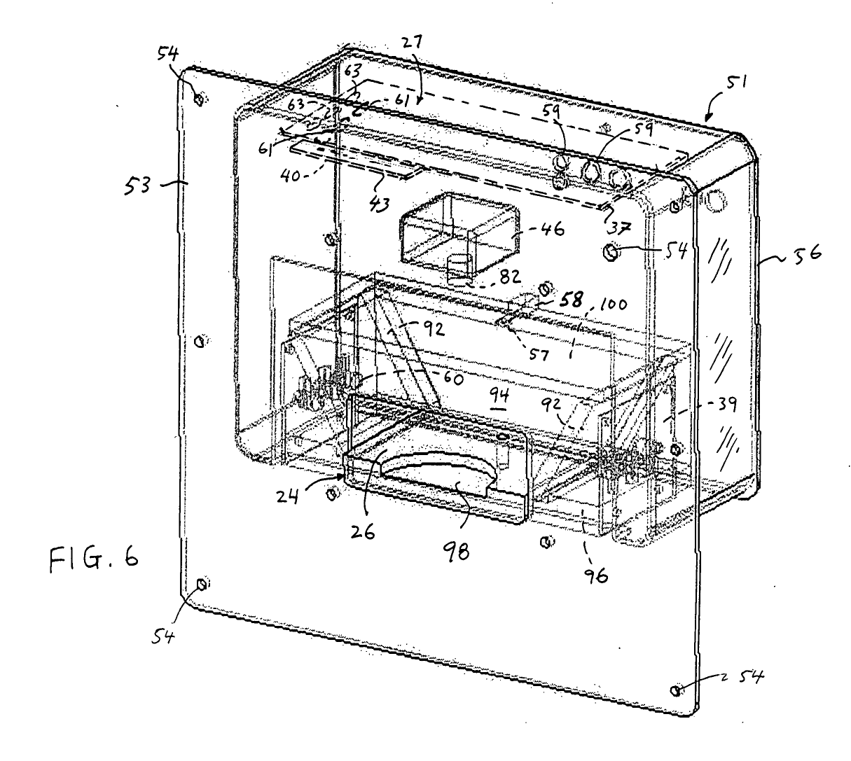

FIG. 2 is an overall block diagram of the verification system. It shows the insertion of an ID card (e.g., a driver's license) 30 onto the card receiving region 26 of the light tray 24. A phototransistor 32 is positioned in the light tray so as to receive light from an infrared (IR) LED 57. When an ID card is fully inserted into the card receiving region 26, the card occludes the IR light, thereby causing the phototransistor to no longer be in full conduction (saturation). The electronic circuitry 27 communicates with the phototransistor and in response to occlusion thereof (no longer being in full conduction), initiates a one-half second delay timer 34, which in turn triggers a three-second delay timer 36. A video switching circuit 38 which is controlled by the output of the three-second delay timer 36 initiates video switching between the camera 42 (used to record images in front of the verification system such as those of the person presenting the card to the operator of the verification system) and the camera 46 used to record the image of the exposed surface of the ID card. As seen in FIG. 2, camera 46 is shown in a phantom region positioned above the phototransistor 32, with FIG. 6 showing the spacial relationship of camera 46 in regard to the light tray 24. Infrared (IR) LED 57 (also shown in phantom) is positioned above phototransistor 32 so that the ID card blocks the IR light from the IR LED 57 when properly inserted into the card receiving region 26 of light tray 24.

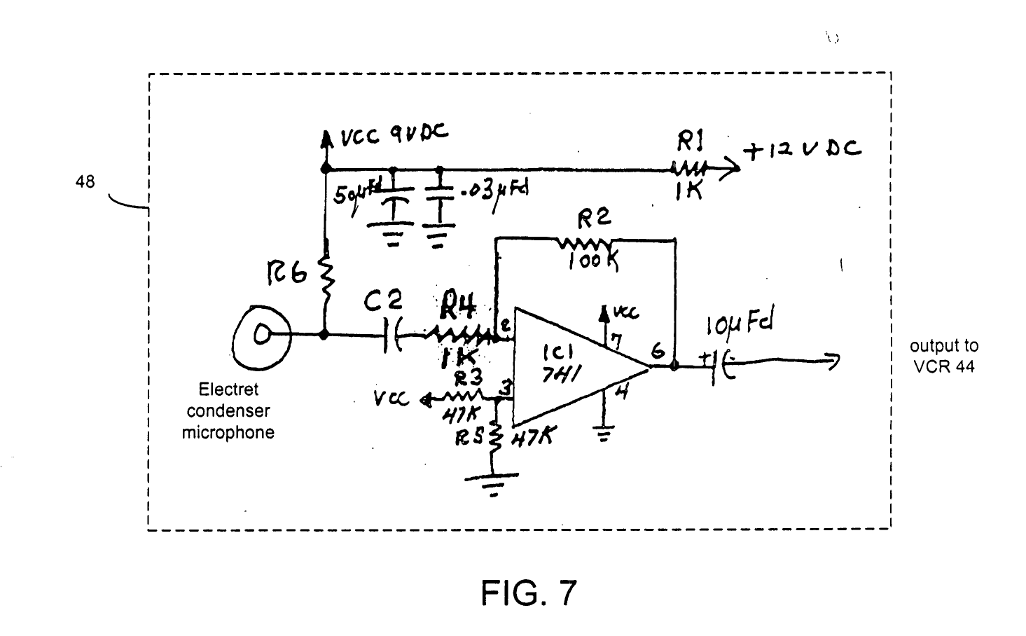

Whenever the identification system is powered, a VCR 44, or other video recording device such as a DVD recorder or the like, is also powered and automatically records either information coming from camera 42 or from camera 46. The VCR 44 also continually records audio input from the microphone 48. In addition, the VCR 44 also continually records a date/time stamp generated by clock stamp generator 40 shown in FIG. 2. The information from ID camera 46 and from camera 42 is recorded on the VCR 44 so that the image information from camera 42 is normally continuously recorded, except for a short period of time, typically three seconds (see three-second delay timer 36), when the ID card 30 is fully inserted within the card receiving region of the light tray, at which time the image from the ID camera 46 is recorded. In addition, microphone 48 records the audio information onto the VCR 44 for purposes of providing further information concerning the person presenting the ID card to the operator of the verification system. The recording of the audio may be disabled if desired. Details of the circuitry for the microphone are presented in FIG. 7.

As set forth above, the monitor 50, such as an LCD monitor, displays the video and audio information recorded on the VCR 44 or other recording device for purposes of ensuring proper operation of the verification system and to show people entering the establishment that they are being recorded. As seen in FIG. 2, the audio/video information from the video identification verification system can also be presented to external devices such as a remote monitor (not shown). As seen in FIG. 2, a power supply 52 provides the necessary power to the overall verification system for operation thereof. This power supply is in turn powered by utility power source such as 110 VAC.

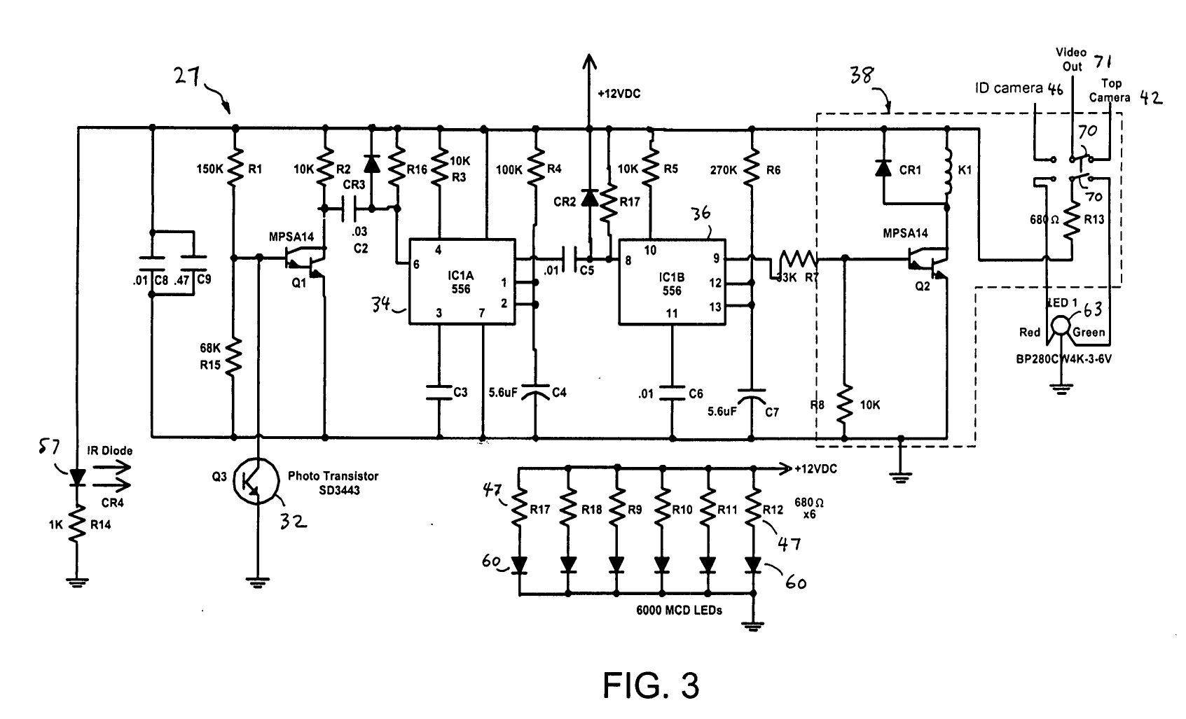

FIG. 3 is an overall schematic diagram of the electronic circuitry 27 used in the verification system. This schematic diagram corresponds to the block diagram shown in FIG. 2. In particular, it shows the phototransistor 32, IR diode 57, the one-half second delay timer 34, the three-second delay timer 36 and the video switching circuit 38. The electronic circuitry also includes resistors 47 used to provide proper operating current to LEDs 60, which are used for illuminating the light tray 24. In operation, when the ID card is inserted fully within the card receiving region 26, it occludes phototransistor 32 so that its operating characteristics change (no longer in full conduction). This change in the phototransistor raises the voltage with regard to transistor Q1 (see FIG. 3), pulling the collector of Q1 to approximately 0.5 volt. This voltage of the collector in turn triggers the start of the one-half second timer 34 having a typical duration of one-half second. This one-half second timer is used to allow the operator of the verification system to remove his or her fingers from the ID card so as not to record the operator's fingers in the information recorded on the VCR 44. When the one-half second delay timer times out, it causes the three-second delay timer 36 to in turn initiate a three-second time period which is used for purposes of recording the image of the ID card inserted within the light tray. This operation is performed by the output of the second timer 36 at pin 9 causing transistor Q2 to turn on, which in turn causes current flow through coil K1 so as to close relay contacts 70 associated with the coil, thereby changing the video-out connection 71 to ID camera 46, rather than to the default camera 42. Thus, the contact shown in FIG. 3 switches from the camera 42 to the ID camera 46 during the three-second duration associated with the three-second delay timer 36. The time/date stamp from time/date generator 40 is normally added to the video information recorded by camera 42 for recording by the VCR. Thus, there is a date/time stamp associated with all of the information both prior to and after recording of the video information associated with the ID card. Of course, if desired, the date/time stamp could be included with the information recorded concerning camera 46, but in general this is not desirable since it would potentially occlude some of the information on the ID card.

As seen in FIG. 6, the electronic circuitry 27 (as mounted on a printed circuit (PC) board 37) and the time/date generator 40 (as mounted on a daughter board 43) are preferably housed in control module 51. The daughter board is preferably soldered to the main PC board. The time/date generator as detailed in Table 2 also includes tamper-evident seals 61 to show if the device has been altered. Sealed adjustment holes 63 in a side wall of control module 51 allow for authorized service adjustment to the time/date generator 40. Connectors 59 provide for connections to the LEDs circuitry, VCR and other components of the video identification verification system using wiring or cables (not shown) well known in the art. These connectors are shown in phantom and are in the back wall 56 of control module 51. The control module also houses the light tray 24. The control module has a face plate 53 and mounting hole 54 for securing the control module to cabinet 21 by fasteners 55 as best seen in FIG. 1.

In addition, as seen in FIG. 3, there may be status indicators LEDs 63 which may preferably have different colors, such as red and green, which show the state of the verification system; that is, whether it is recording from the top camera (the green LED 63) or the ID camera 46 (the red LED). Of course, the color of the indicators and the use of the indicators may be changed as desired.

Details of the power supply 52 associated with the schematic diagram shown in FIG. 2 are presented in Table 1. Details of the date/time stamp generator are presented in Table 2. Details of a typical LCD monitor such as 5.6-inch TFT LCD monitor are presented in Table 3.

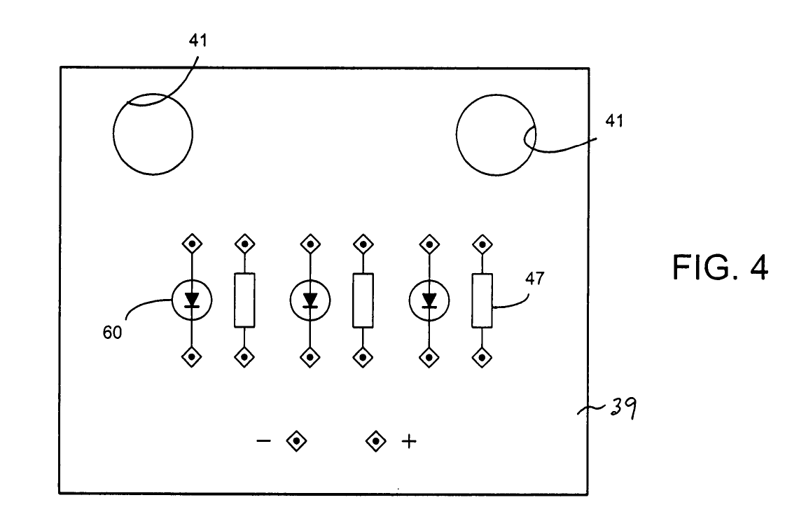

FIG. 4 shows details of a light emitting mounting board 39 for use in mounting LEDs 60. As seen there, as well as in FIG. 3, current limiting resistors 47 (R9-R12, R17, R18) are used to limit the current associated with the LEDs 60. The LEDs are preferably 6,000 millicandle (MCD) LEDs. The LEDs preferably in combination produce a whitish-bluish colored light. Preferably two of the LEDs in each LED mounting board produce a white colored light and a third LED (preferably the middle LED) produces a bluish colored light. Although three LEDs are shown associated with each mounting board 39, more or fewer LEDs can be used to provide the proper amount and coloration of the illumination for the ID when placed within the light tray. The LED mounting board is secured to the bottom wall 96 of the light tray 24 by use of mounting holes 41 and associated fasteners. Of course, other means can be used (such as gluing) to secure the mounting board to the light tray.

Details of the light tray 24 are presented in FIG. 5. As seen there, the LED mounting board 39 is mounted to the bottom wall 96 so as to position the LEDs toward the respective side wall diffusers of the light tray. As seen in FIG. 5, the side wall diffusers have a preferable angle of 61 degrees relative to the bottom wall 96 of the light tray. This angle has been found through experimentation to provide the best illumination for the ID card 30 placed within the light tray. It has also been found through experimentation that this angle can range from approximately 35 degrees to 64 degrees and still provide acceptable illumination of the identification card, even when the ID card has a highly reflective front surface and has printing and images in multiple colors. The resulting light tray is effective in illuminating ID cards that are in color. Video camera 46 is preferably a color video camera so as to record the ID card images in color.

The back wall 94 and the bottom wall 96 of the light tray are preferably formed from methacrylate resin slab type material such as Corian® slab stock sold by E. I. DuPont Demours and Company Corporation of Wilmington, Del. The bottom wall includes a cutout recess generally shown by reference numeral 98 to facilitate insertion and removal of the ID card in the card receiving region of the bottom wall. The diffuser side walls have been found to be preferably fabricated from an acrylic sheet material such as Polycast® 2447 sold by San Diego Plastics, Inc. of National City, Calif. 91950. The light tray may further include a glass portion 100 positioned over the top of the side and back walls so as to minimize the entry of dust and other contaminants within the identification verification system cabinet. A camera lens 82 is positioned to look down through this glass top. Camera 46 is positioned on the opposite side of the camera lens and is thereby able to image the ID card when fully positioned within the card receiving region 26 of light tray 24.

The bottom wall and back of the light box, as indicated earlier, are preferably fabricated from Corian® methacrylate resin slab type material which has relatively low static properties, thereby minimizing the potential for static damage to the electronic circuitry of the identification verification system. This product also provides a smooth feel to the user, thereby facilitates use of the system for inserting and removing ID cards. A clear top wall 100 made from glass or other transparent material helps keep dust out of the light tray. The IR LED 57 and holder 58 can be mounted to this top wall.

Important with regard to this video identification verification system is the design of the light box, which through experimentation has been found to provide proper illumination of an inserted ID card into the tray even if the ID card has a highly reflective surface and has imprinting thereon in multiple colors. It had earlier been found that the acceptable video recording of an image of such ID card is extremely difficult to obtain unless the tray has the diffuser side walls as described herein in association with the illumination source as described herein. The overall result is a video identification verification system which has been found to provide accurate recording of ID cards while also providing recording of the person in front of the video identification verification system so as to show the condition of the person presenting the card. General audio information is also recorded.

Thus, what has been described is a video identification verification system that provides an easy and accurate way to record ID card information along with information about the person presenting the card. It will be appreciated that changes to this video identification verification system can be made within the scope of the present invention.

TABLE 1
2-12 volt and 1-9 volt power supplies

12 volt regulated model: DSA-0151-12
input: 100-240 v˜
0.40 A max. 47 HZ-63 HZ
output: +12 V-1.25 A
Ulᵣ listed, Saᵣ Level 3
9 volt model: YK-09060U
input: AC 120 V, 60 HZ 9.0 W
output: DC 9 V, 600 MA
UL listed, Class 2 power supply

TABLE 2

Time/date stamp generator
Model WJ-180
Lithium battery-operated
Manufacturer: WOOJU Communications
Co., Ltd., Incheon, Korea

TABLE 3
5.6 inch color TFT LCD Monitor

| | |
|---|---|
| Screen size: | 5.6 inch 116 (H) × 87 (V) mm. |
| Active area: | 111.36 (H) × 83 (V) mm. |
| Drive system: | A-Si TFT active matrix |
| Screen color: | full color |
| Dot matrix: | 320 (H) × RGB × 240 (V) dots |
| Dot pitch: | 0.116 (H) × 0.348 (V) |
| Overall dimension: | 162 (H) × 133 (V) × 54 (D) |
| Contract ratio: | 85:1 |
| Luminosity: | 270 cd/m |
| Sound output: | 200 mw × built in 4 cm speaker, 1 piece |
| Input terminals: | power input, video input, audio input |
| Consumption power: | DC 12 V/600 ma, 8 W (MAX) |
| Power input: | DC 9 V˜20 V, pin 2.0 |
| Video input: | 0.75 Vp-p˜1 Vp-p, pin 3.5 |
| Screen display: | reverse/normal switchable (R<->N) |
| Operate temperature: | −40 degrees C˜+95 degrees C |

What is claimed is:

1. A lighting system for illuminating identification cards comprising:
a light tray having a bottom wall having a region dimensioned for receipt of an identification (ID) card, the light tray further having at least one side wall diffuser positioned relative to the bottom wall at an angle of from approximately 35 to 64 degrees; and
a light source positioned relative to the side wall diffuser so as to cause light to pass through the diffuser into the light tray so as to illuminate the ID card placed on the bottom wall for imaging by a video camera.

2. A lighting system as defined in claim 1, wherein the angle of the at least one side wall diffuser relative to the bottom wall is approximately 61 degrees.

3. A lighting system as defined in claim 1, wherein the light source is at least one light emitting diode.

4. A lighting system as defined in claim 1, further comprising a second side wall diffuser positioned relative to the bottom wall at an angle of from 35 to 64 degrees, said second side wall diffuser positioned on the bottom wall so as to face toward the first side wall diffuser.

5. A lighting system as defined in claim 4, wherein the light source is at least one light emitting diode (LED) associated with each side wall diffuser.

6. A lighting system as defined in claim 5, wherein the light source is two white colored LEDs associated with each side wall diffuser.

7. A lighting system as defined in claim 6, wherein the light source further comprises at least one additional LED having a bluish color associated with each side wall diffuser.

8. A lighting system as defined in claim 7, wherein each LED has an illumination output of approximately 6,000 millicandle (MCD).

9. A lighting system as defined in claim 7, wherein the LEDs associated with each side wall diffuser are mounted on a board which is positioned relative to the bottom wall of the light tray so that the LED illumination is directed toward the associated side wall diffuser.

10. A lighting system as defined in claim 9, wherein each side wall diffuser is fabricated from a translucent acrylic sheet material.

11. A lighting system as defined in claim 10, wherein the acrylic sheet material is a Polycast® 2447 material.

12. A lighting system as defined in claim 1, wherein the light tray further comprises a back wall fastened to the side wall diffusers and to the bottom wall.

13. A lighting system as defined in claim 12, wherein the bottom wall and back wall are fabricated from a methacrylate resin slab type material.

14. A lighting system as defined in claim 4, wherein each side wall diffuser is fabricated from a translucent acrylic sheet material.

15. A lighting system as defined in claim 14, wherein the acrylic sheet material is a Polycast® 2447 material.

16. A lighting system as defined in claim 14, wherein the light tray further comprises a back wall fastened to the side wall diffusers and to the bottom wall.

17. A lighting system as defined in claim 16, wherein the bottom wall and back wall are fabricated from a methacrylate resin slab type material.

18. A lighting system as defined in claim 12, wherein the light tray further comprises means for determining if an ID card is inserted within the bottom wall region dimensioned for receipt of an ID card.

19. A lighting system as defined in claim 1, wherein the light tray further comprises means for determining if an ID card is inserted within the bottom wall region dimensioned for receipt of an ID card.

20. A video identification verification system comprising:
a light tray having a bottom wall having a region dimensioned for receipt of an identification (ID) card, the light tray further having at least one side wall diffuser positioned relative to the bottom wall;
a light source positioned relative to the side wall diffuser so as to cause light to pass through the diffuser into the light tray so as to illuminate the ID card placed on the bottom wall;
a first camera positioned in juxtaposed spaced relationship to the light tray so as to be able to image an ID card placed on the bottom wall region dimensioned for receipt of the ID card;
electronic circuitry for controlling activation of the first camera so as to cause the image of the first camera to be recorded on an associated video recording device.

21. A video identification verification system as defined in claim 20, further comprising a cabinet within which the light tray and first camera are positioned, the verification system further comprising a second video camera positioned on the cabinet so as to image an area extending in a direction away from the cabinet so as to be able to record the image of a person presenting the ID card to be imaged by the verification system, wherein the electronic circuitry further comprises means for recording video information from the second video camera onto the video recording device.

22. A video identification verification system as defined in claim 21, wherein electronic circuitry for recording the video information from the second video camera onto the video recording device controls such recording so as to occur during times prior to and/or after recording of the image associated with the ID card inserted into the light tray.

23. A video identification verification system as defined in claim 22, further comprising at least one microphone in cooperative engagement with the electronic circuitry for recording audio information in the vicinity of the video identification verification system onto the video recording device.

24. A video identification verification system as defined in claim 23, wherein the light tray further includes means for determining if an ID card is inserted within the bottom wall region dimensioned for receipt of an ID card, said means communicating with the electronic circuitry for causing the first video camera to image the ID card when it is fully inserted within the light tray.

25. A video identification verification system as defined in claim 24, further comprising a time/date stamp generator for generating a time of day and date video stamp image that is combined with the video image from the second video camera so that the time and date associated with the insertion of the ID card into the light tray is recorded.

26. A video identification verification system as defined in claim 25, wherein the time/date stamp generator is mounted within the cabinet in a tamper evident manner.

27. A video identification verification system as defined in claim 22, wherein the light tray further comprises a second side wall diffuser positioned relative to the bottom wall and wherein the light source includes a portion thereof so as to cause light to pass through the second side wall diffuser into the light tray.

28. A video identification verification system as defined in claim 27, wherein the first and second side wall diffusers are positioned relative to the bottom wall at an angle of from approximately 35 to 64 degrees.

29. A video identification verification system as defined in claim 28, wherein the first and second side wall diffusers are positioned relative to the bottom wall at an angle of approximately 61 degrees.

30. A video identification verification system as defined in claim 29, wherein the light source comprises at least one LED positioned relative to each side wall diffuser.

31. A video identification verification system as defined in claim 30, wherein the light source comprises two white-colored LEDs and at least one bluish-colored LED associated with each side wall diffuser.

32. A video identification verification system as defined in claim 31, wherein each LED has illumination output of approximately 6,000 millicandle (MCD).

33. A video identification verification system as defined in claim 32, wherein each side wall diffuser is fabricated from a translucent acrylic sheet material.

34. A video identification verification system as defined in claim 33, wherein the sheet material is a Polycast®2447 material.

35. A video identification verification system as defined in claim 34, wherein the light tray further comprises a back wall fastened to the side wall diffusers and to the bottom wall.

36. A video identification verification system as defined in claim 35, wherein the bottom wall and the back wall are fabricated from a methacrylate resin slab type material.

37. A video identification verification system as defined in claim 21, wherein the light tray and first video camera and electronic circuitry are mounted within a control module, wherein the control module is dimensioned for removable connection with a side wall of the cabinet and further having connector means for interconnecting the electronic circuitry to the associated video recording device.

38. A video identification verification system as defined in claim 37, wherein the associated video recording device is mounted within the cabinet.

39. A video identification verification system as defined in claim 38, further comprising a video monitor in cooperative engagement with the video recording device for displaying at least video information associated from the first and second video cameras.

40. A video identification verification system as defined in claim 39, wherein the video monitor is positioned within the cabinet.

41. A video identification verification system as defined in claim 40, wherein the cabinet comprises a front door made from a transparent material and wherein the video monitor is positioned within the cabinet so as to be seen through the front door.

42. A video identification verification system as defined in claim 41, wherein the front door further comprises a key lock to minimize access to the contents within the cabinet.

43. A video identification verification system as defined in claim 42, wherein the image of the ID card inserted within the light tray is imaged by the first video camera for approximately three seconds after the card is inserted within the light tray.

44. A video identification verification system as defined in claim 43, further comprising a short time delay after initial insertion of the ID card into the light tray so as to minimize recording of the fingers of the person inserting the ID card within the light tray.

45. A method of recording the image of an identification card presented for identification of a person comprising the steps of:
recording an area associated with a location where a person will present an ID card for purposes of identification;
inserting an ID card into a light tray;
imaging the ID card when it is inserted into the light tray for a predetermined period of time; and
re-imaging the area in the region where a user will present an ID card after imaging of the ID card.

46. A method as defined in claim 45, further comprising a date/time stamp which is generated in combination with the image in the area associated with the region where a user will present an ID card so as to generate a video signal with a date/time stamp for determining when the ID card was presented for purposes of identification.

47. A method as defined in claim 46, wherein the image of the ID card is not initiated until a short time delay after its insertion into the light tray so as to minimize recording of the image of the fingers of a user inserting the ID card into the light tray.
